(19) United States
(12) Patent Application Publication
(10) Pub. No.: US 2005/0157323 A1
(43) Pub. Date: Jul. 21, 2005

(54) Printing device and printing method

(75) Inventors: Atsushi Narusawa, Nagano-ken (JP); Satoru Orii, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/976,326

(22) Filed: Oct. 29, 2004

(30) Foreign Application Priority Data
Oct. 29, 2003 (JP) 2003-369031

(51) Int. Cl. G06F 15/00

(52) U.S. Cl. 358/1.13; 358/1.16

(57) ABSTRACT

A printer 20, which has functions of analyzing and printing an XHTML document, additionally has an SVGPI 37 that analyzes SVG statements and draws vector figures. The SVGPI 37 is activated, in place of an XML parser 34, to analyze each SVG statement included in a specified XHTML document, create an element, and additionally register the created element in a DOM tree. A layouter 38 lays out an element box corresponding to the created element, based on dimensions of the element box specified by the SVGPI 37. An RPI 40, in cooperation with the SVGPI 37, draws the created element in a memory 50.

### BACKGROUND OF THE INVENTION

1. Field of the Invention

The present invention relates to a printing device and a corresponding printing method. More specifically the invention pertains to a printing device that analyzes a document, which describes printable objects in a hierarchical manner, and prints the objects on a medium, such as paper, as well as to a corresponding printing method.

2. Description of the Prior Art

One proposed printer system includes a printer that analyzes and prints an SVG document and a formatting server that converts an HTML document into the SVG document (see, for example, Japanese Patent Laid-Open Gazette No. 2002-91726). In this proposed printer system, the formatting server converts a received HTML document into an SVG document, and the printer analyzes and prints the converted SVG document.

### SUMMARY OF THE INVENTION

This prior art printer system including the printer and the formatting server is, however, undesirably large in size and is unsuitable for a restricted space, such as a living room in a house. This printer system converts the received HTML document into the SVG document and analyzes and prints the converted SVG document. Such conversion and analysis take a relatively long time and undesirably interfere with prompt printing. The prior art technique is not specifically designed to print a document including statements written in HTML language and statements written in another language.

The printing device and the corresponding printing method of the invention thus aim to analyze and print a document that describes objects in a hierarchical manner in a preset format and includes a statement written in another format, for example, an HTML document or an extensible HTML document including a statement written in a different format.

At least part of the above and the other related objects is attained by a printing device and a corresponding printing method of the invention constructed as discussed below.

The printing device of the invention is the printing device that analyzes a document of describing printable objects in a hierarchical manner and prints the objects on a medium, such as paper, and the printing device includes: a data storage module that stores data; a statement analysis module having a main analyzer unit and at least one auxiliary analyzer unit, where the main analyzer unit analyzes a statement of describing a printable object with an identifier in a preset format and the auxiliary analyzer unit analyzes a statement of describing a printable object with an identifier in another format different from the preset format; a structural analysis module that, in response to specification of one document, analyzes a hierarchical tree structure of the objects included in the specified document, in cooperation with the main analyzer unit and the auxiliary analyzer unit included in the statement analysis module, and stores the analyzed tree structure into the data storage module; a layout setting module that, in response to a layout command, determines a layout of the objects in each page on the medium based on the tree structure stored in the data storage module, in cooperation with the main analyzer unit and the auxiliary analyzer unit included in the statement analysis module, and stores the determined layout in each page into the data storage module; and a print execution module that, in response to a print command, fetches the objects according to the determined layout in each page stored in the data storage module and lays out and prints the fetched objects on the medium.

The printing device of the invention analyzes the hierarchical tree structure of the printable objects included in the specified document, in cooperation with the main analyzer unit that analyzes a statement of describing a printable object with the identifier in the preset format and the auxiliary analyzer unit that analyzes a statement of describing a printable object with the identifier in the another format different from the preset format. The printing device determines the layout of the objects in each page on the medium based on the analyzed tree structure, in cooperation with the main analyzer unit and the auxiliary analyzer unit, and lays out and prints the objects according to the determined layout. The printing device of this arrangement thus ensures adequate analysis and printing of a document, which includes a statement with the identifier in the different format, in addition to statements with the identifier in the preset format. The document may be described in a markup language. The printing device may be any of diverse printers, for example, a color inkjet printer or a laser printer.

In the printing device of the invention, the structural analysis module may activate the auxiliary analyzer unit of the statement analysis module, in the case of failed analysis of a statement by the main analyzer unit of the statement analysis module. Further, the statement may specify a type of each object, and the structural analysis module may analyze the tree structure, based on an identifier and the specified type of each object. Moreover, the auxiliary analyzer unit may give a printing size of the object described in the analyzed statement as part of the analysis, and the layout setting module may refer to the printing size of the object given as part of the analysis by the auxiliary analyzer unit and determines the layout of the objects. Furthermore, the structural analysis module may give the layout command with specification of the analyzed tree structure to the layout setting module, after the analysis of the tree structure.

Further, in the printing device of the invention, the layout setting module may give the print command for each page with the determined layout to the print execution module. Moreover, the layout setting module may give the print command on completion of determination of the layout for one page to the print execution module.

In the printing device of the invention, the preset format may describe an object corresponding to at least one of a text, an image, and a table, and the another format may describe an object corresponding to at least one of a figure, a combination of figures, and a mathematical expression. In this case, the statement of describing the printable object with the identifier in the preset format may be a statement written in XHTML language, and the statement of describing the printable object with the identifier in the another format may be a statement written in one of SVG language, MathML language, and CML language.

The printing method of the invention is the printing method that analyzes a document of describing printable objects in a hierarchical manner and prints the objects on a medium, such as paper, and the printing method includes the steps of: (a) in response to specification of one document, analyzing each statement included in the specified document on the assumption of a statement with an identifier in a preset format, and in the case of failed analysis of the statement on the assumption of the statement with the identifier in the preset format, subsequently analyzing the statement on the assumption of a statement with an identifier in another format different from the preset format, so as to complete analysis of a hierarchical tree structure of the objects included in the specified document; (b) in response to a layout command, laying out each object of the tree structure analyzed on the assumption of the statement with the identifier in the preset format, based on the statement with the identifier in the preset format, while laying out each object of the tree structure analyzed on the assumption of the statement with the identifier in the another format, based on a printing size of the object given as part of the analysis of the statement, so as to determine a layout of the objects in each page on the medium; and (c) in response to a print command, fetching the objects according to the determined layout in each page and laying out and printing the fetched objects on the medium.

The printing method of the invention completes analysis of the hierarchical tree structure of the objects included in a specified document by analyzing each statement included in the specified document on the assumption of the statement with the identifier in the preset format, and in the case of failed analysis of the statement on the assumption of the statement with the identifier in the preset format, subsequently analyzing the statement on the assumption of the statement with the identifier in the another format different from the preset format. The printing method lays out each object of the tree structure analyzed on the assumption of the statement with the identifier in the preset format, based on the statement with the identifier in the preset format, while laying out each object of the tree structure analyzed on the assumption of the statement with the identifier in the another format, based on the printing size of the object given as part of the analysis of the statement, so as to determine the layout of the objects in each page on the medium. The printing method fetches the objects according to the determined layout in each page and lays out and prints the fetched objects on the medium. This arrangement ensures adequate analysis and printing of a document, which includes a statement with the identifier in the different format, in addition to statements with the identifier in the preset format.

A storage medium of the invention is a storage medium in which a program is stored, where the program is used in a printing device that analyzes a document of describing printable objects in a hierarchical manner and prints the objects on a medium, such as paper, and the program includes: a statement analysis module having a main analyzer module and at least one auxiliary analyzer module, where the main analyzer module analyzes a statement of describing a printable object with an identifier in a preset format and the auxiliary analyzer module analyzes a statement of describing a printable object with an identifier in another format different from the preset format; a structural analysis module that, in response to specification of one document, analyzes a hierarchical tree structure of the objects included in the specified document, in cooperation with the main analyzer module and the auxiliary analyzer module included in the statement analysis module; a layout setting module that, in response to a layout command, determines a layout of the objects in each page on the medium based on the analyzed tree structure, in cooperation with the main analyzer module and the auxiliary analyzer module included in the statement analysis module; and an execution module that, in response to a print command, fetches the objects according to the determined layout in each page and lays out and prints the fetched objects on the medium.

The storage medium of the invention installs the stored program into the printing device. The printing device with the installed program analyzes the hierarchical tree structure of the printable objects included in a specified document, in cooperation with the main analyzer module that analyzes a statement of describing a printable object with the identifier in the preset format and the auxiliary analyzer module that analyzes a statement of describing a printable object with the identifier in the another format different from the preset format. The printing device with the installed program determines the layout of the objects in each page on the medium based on the analyzed tree structure, in cooperation with the main analyzer module and the auxiliary analyzer module, and lays out and prints the objects according to the determined layout. The program of the invention thus enables the printing device to adequately analyze and print a document, which includes a statement with the identifier in the different format, in addition to statements with the identifier in the preset format.

### BRIEF DESCRIPTION OF THE DRAWINGS

FIG. 1 schematically illustrates the structure of a color inkjet printer 20 in one embodiment;

FIG. 2 is a flowchart showing an analysis layout instruction process;

FIG. 3 is a flowchart showing an analysis process;

FIG. 4 shows one example of an XHTML document;

FIG. 5 shows images described in the XHTML document of the example;

FIG. 6 shows a vector figure written as an SVG statement;

FIG. 7 shows one example of a DOM tree;

FIG. 8 shows one example of a CSS document;

FIG. 9 shows one example of a style object;

FIG. 10 is a flowchart showing a layout drawing instruction process;

FIG. 11 is a flowchart showing a layout process;

FIG. 12 shows one example of a page box;

FIG. 13 is a flowchart showing a drawing process; and

FIG. 14 shows one example of a printing result.

### DESCRIPTION OF THE PREFERRED EMBODIMENTS

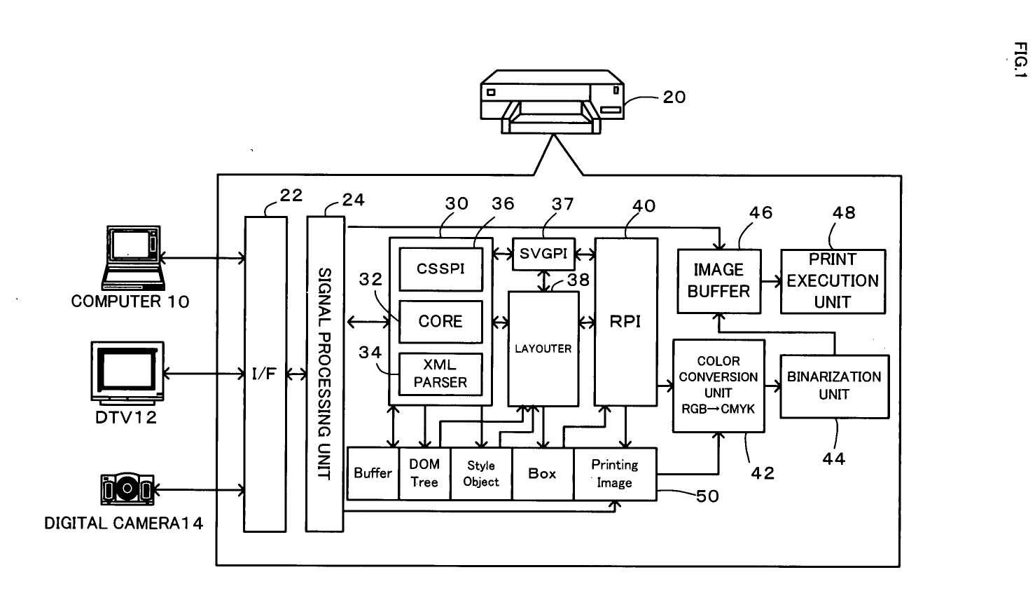

One mode of carrying out the invention is described below as a preferred embodiment. FIG. 1 schematically illustrates the structure of a color inkjet printer 20 in one embodiment of the invention. The color inkjet printer 20 of this embodiment includes an input interface 22 that is connected with a computer 10, a digital TV receiver 12, or a digital camera 14 to input digital images (hereafter simply referred to as images), a signal processing unit 24 that determines an output destination of data according to the format of each image input by the input interface 22, and an analyzer unit 30 that analyzes an XHTML document described in a markup language XHTML (extensible Hyper Text Markup Language) to create a DOM (Document Object Model) tree as an object tree structure, reads a CSS (Cascading Style Sheets) document described in CSS to create a style object, and writes the DOM tree and the style object into a memory 50. The color inkjet printer 20 also includes a layouter 38 that lays out images and text as objects described in the XHTML document on each printing page based on the DOM tree and the style object created by the analyzer unit 30 and writes each laid out printing page as a page box into the memory 50, a rendering plug-in (hereafter referred to as RPI) 40 that draws a printing image in the form of RGB (red, green, blue) data by utilizing the page box laid out by the layouter 38, a color conversion unit 42 that converts a printing image of the drawn RGB data into CMYK (cyan, magenta, yellow, black) data, a binarization unit 44 that makes the converted CMYK data subjected to error diffusion or another required series of image processing to binarize the CMYK data, an image buffer 46 that temporarily accumulates data in order to output the binarized CMYK data in units of bands to a print execution unit 48 with a non-illustrated print head, and an SVG plug-in (hereafter referred to as SVGPI) 37 that analyzes statements written in SVG (Scalable Vector Graphics) as a standard vector graphic format embedded in the XHTML document.

The signal processing unit 24 outputs immediately-printable print data to the image buffer 46 of the print execution unit 48, RGB data to a printing image storage area of the memory 50, and a file of the XHTML document to the analyzer unit 30.

The analyzer unit 30 includes a core 32 that gives an analysis command for analysis of the XHTML document to create the DOM tree, an XML parser 34 that analyzes the XHTML document in response to the analysis command given by the core 32, and a CSS plug-in (hereafter referred to as CSSPI) 36 that analyzes the CSS document in response to a request given by an initialization process in a link tag of the created DOM tree.

The SVGPI 37 analyzes each SVG statement that is embedded in the XHTML document but is not processible by any of the analyzer unit 30, the layouter 38, and the RPI 40. In response to an instruction from the analyzer unit 30, the SVGPI 37 functions as a module of causing the core 31 of the analyzer unit 30 to recognize the SVG statement as an SVG element and add the SVG element to the DOM tree. In response to an instruction from the layouter 38, the SVGPI 37 functions as a module of causing the layouter 38 to specify vertical and lateral printing dimensions of a vector figure as dimensions of an element box and layout the SVG element as an element box. In response to an instruction from the RPI 40, the SVGPI 37 functions as a module of causing the RPI 40 to actually draw the vector figure.

The following describes operations of the color inkjet printer 20 of the embodiment constructed as discussed above, especially a series of operations to print an XHTML document with an SVG statement embedded therein.

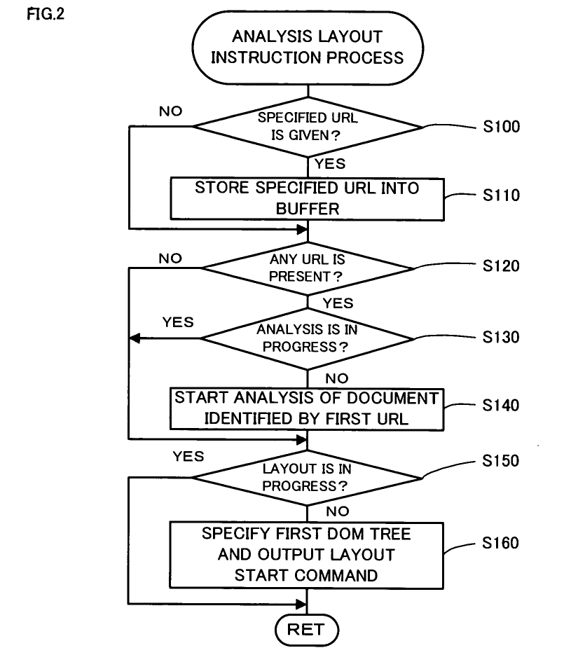

FIG. 2 is a flowchart showing an analysis layout instruction process executed by the analyzer unit 30. This process is executed repeatedly at preset time intervals (for example, at every 8 msec). In the analysis layout instruction process, the analyzer unit 30 first determines whether a specified URL (Uniform Source Locator) is given to identify an XHTML document (step S100). When a specified URL is given, the URL is stored in a URL storage buffer area set in the memory 50 (step S110). When no specified URL is given, on the other hand, the program proceeds to a next step. The specified URL may be output, for example, from the digital TV receiver 12 to the color inkjet printer 20 when the operator selects a desired option to be printed by the color inkjet printer 20 among printable options displayed on the digital TV receiver 12. The specified URL may be selected simply by the computer 10 to give a print command to the color inkjet printer 20. The computer 10 has functions of executing analysis of the XHTML document, layout, color conversion, and binarization. The computer 10 may, however, not execute any of such processing but may send only the specified URL to the color inkjet printer 20.

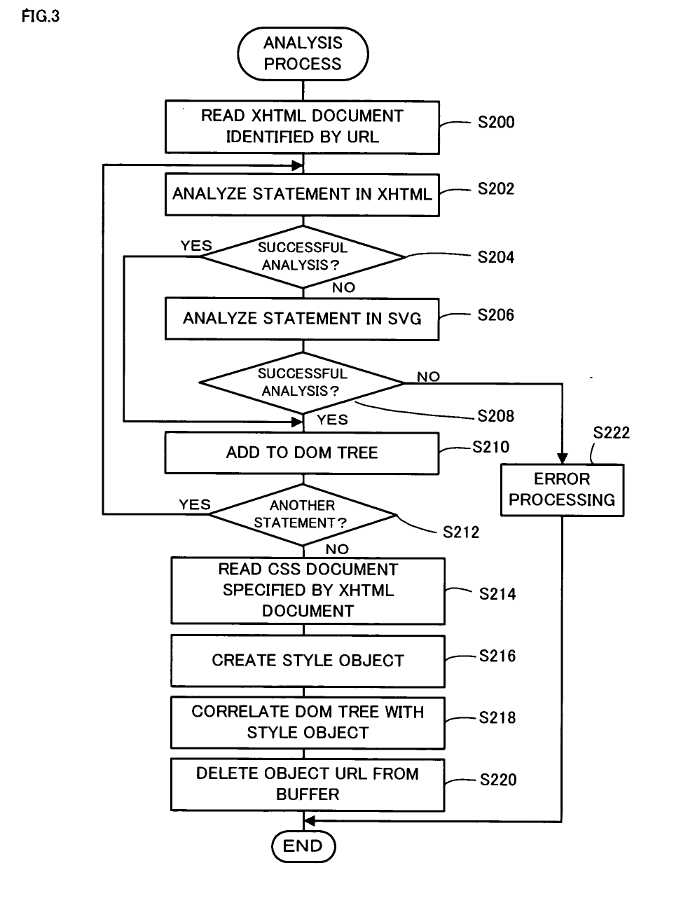

The analyzer unit 30 subsequently determines whether any URL is present in the URL storage buffer area of the memory 50 (step S120) and whether any XHTML document is currently being analyzed (step S130). The analyzing status of an XHTML document is detected, for example, by determining whether the analyzer unit 30 is currently analyzing any XHTML document, simultaneously with and in parallel with this analysis layout instruction process. One concrete procedure may set and reset a flag at the start and the end of analysis. When any URL is present in the URL storage buffer area and no XHTML document is currently being analyzed, the analyzer unit 30 reads out a first URL stored in the URL storage buffer area of the memory 50 and starts analysis of an XHTML document specified by the read out URL (step S140). When no URL is present in the URL storage buffer area or when any URL is present but an XHTML document is currently being analyzed, on the other hand, the program proceeds to a next step. Analysis of the XHTML document is carried out according to an analysis process shown in FIG. 3. The analysis process analyzes an XHTML document identified by a URL to create a DOM tree, analyzes a CSS document specified by the XHTML document to create a style object, correlates the DOM tree with the style object, and stores the correlated DOM tree and style object respectively into a DOM tree storage area and a style object storage area of the memory 50. A DOM tree ID as identification information is assigned to the DOM tree, whereas a style object ID as identification information is assigned to the style object. The details of the analysis process will be discussed later.

The analyzer unit 30 then determines whether the layouter 38 is currently making a layout (step S150). When the layouter 38 is not currently making a layout, the analyzer unit 30 specifies a first DOM tree with the DOM tree ID among DOM trees stored in the DOM tree storage area of the memory 50 and outputs a layout start command to the layouter 38 (step S160), before terminating this analysis layout instruction process. When the layouter 38 is currently making a layout, on the other hand, the analyzer unit 30 terminates the analysis layout instruction process without outputting a layout start command. The layout execution status of the layouter 38 is determined, for example, by detection of input of a layout end signal from the layouter 38. The input of the layout end signal will be described later as part of the processing by the layouter 38.

The analysis layout instruction process is executed in a repeated manner as mentioned above. Every time a specified URL is given, the analyzer unit 30 stores the specified URL into the URL storage buffer area of the memory 50, whether or not an XHTML document is being analyzed. When any URL is present in the URL storage buffer area of the memory 50, the analyzer unit 30 successively analyzes XHTML documents, whether or not the layouter 38 is currently making a layout. This may result in storage of multiple URLs in the URL storage buffer area, storage of multiple DOM trees in the DOM tree storage area, and storage of multiple style objects in the style object storage area of the memory 50. In the structure of this embodiment, the URL storage buffer area, the DOM tree storage area, and the style object storage area are respectively set to have the capacities for storing the multiple URLs, the multiple DOM trees, and the multiple style objects.

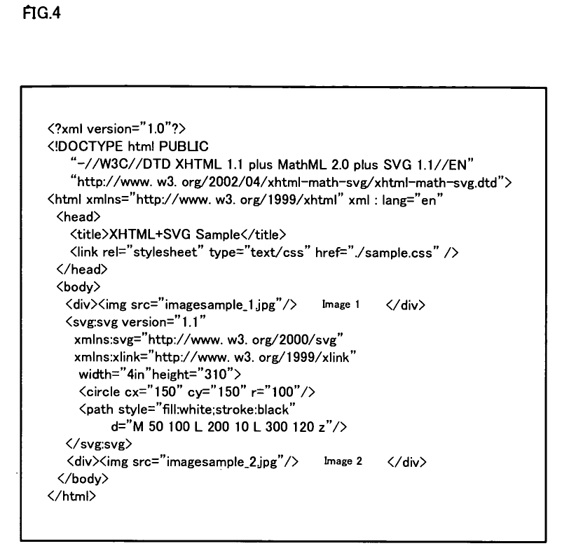

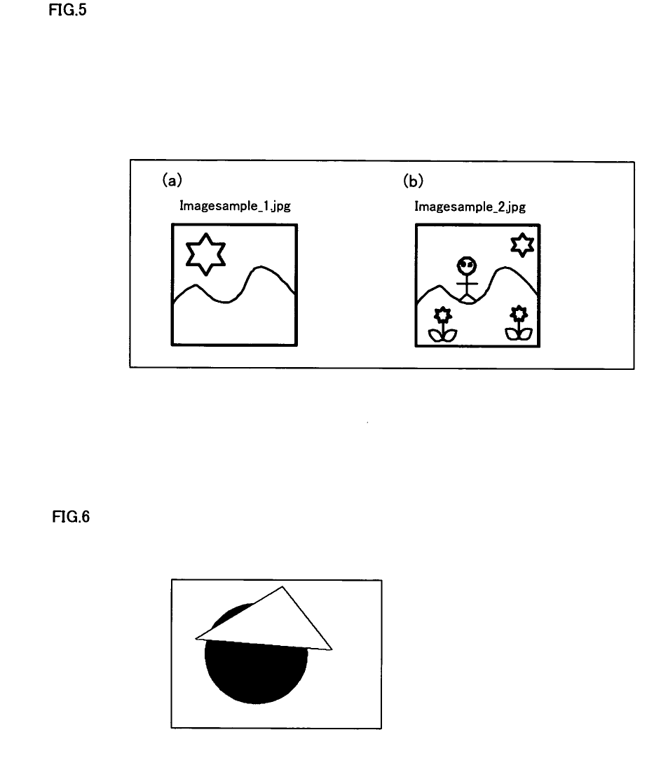

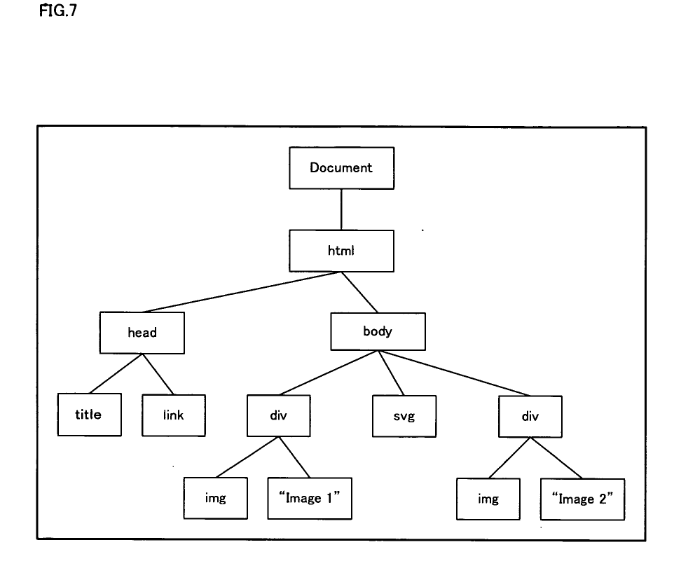

The description regards the analysis process executed by the analyzer unit 30. The analysis process is carried out according to the flowchart of FIG. 3 as mentioned above. As a matter of convenience, the description of the analysis process regards an XHTML document shown in FIG. 4 as one example. FIG. 5 shows two images stored in the JPEG format adopted in the XHTML document of the example. FIG. 6 shows a vector figure written as an SVG statement. When the analysis layout instruction process outputs an analysis start command with a specified URL, the analyzer unit 30 reads an XHTML document identified by the specified URL (step S200) and analyzes a first statement in the XHTML document on the assumption of a statement written in XHTML (step S202). According to the concrete procedure, the core 32 specifies a URL and gives an analysis request to the XML parser 34. The XML parser 34 then reads the XHTML document identified by the URL. In the case of successful analysis as the statement written in XHTML, the analyzer unit 30 creates an element and additionally registers the created element in the DOM tree (additionally registers the created element immediately below a ‘Document’ tag in the case of the first statement) (step S210). The analyzer unit 30 subsequently determines whether the XHTML document has another statement (step S212). When there is a next statement, the processing flow goes back to step S202 to analyze the next statement on the assumption of a statement written in XHTML. The element created here is correlated and additionally registered in the DOM tree storage area of the memory 50. In the illustrated example of FIG. 4, statements down to a ‘div’ tag immediately below a ‘body’ tag are analyzed as the statements written in XHTML. The analyzed XHTML statements are created as elements and are additionally registered in the DOM tree. FIG. 7 shows a DOM tree created by analysis of the XHTML document illustrated in FIG. 4.

In the case of failed analysis as the statement written in XHTML, on the other hand, the analyzer unit 30 instructs the SVGPI 37 to analyze the statement on the assumption of a statement written in SVG (step S206). In the case of successful analysis as the statement written in SVG, the analyzer unit 30 creates an element and additionally registers the created element in the DOM tree (step S210) and determines whether the XHTML document has another statement (step S212). When there is a next statement, the processing flow goes back to step S202 to analyze the next statement on the assumption of a statement written in XHTML. In the illustrated example of FIG. 4, a statement with an ‘svg tag’ next to the ‘div’ tag immediately below the ‘body’ tag fails to be analyzed as the statement written in XHTML but is successfully analyzed as the statement written in SVG. The analyzed SVG statement is created as an svg element and is additionally registered in the DOM tree. In the case of failed analysis as the statement written in SVG, the analyzer unit 30 determines the XHTML document to be unprintable by the color inkjet printer 20 of the embodiment and executes a series of error processing (step S222), before terminating this analysis process.

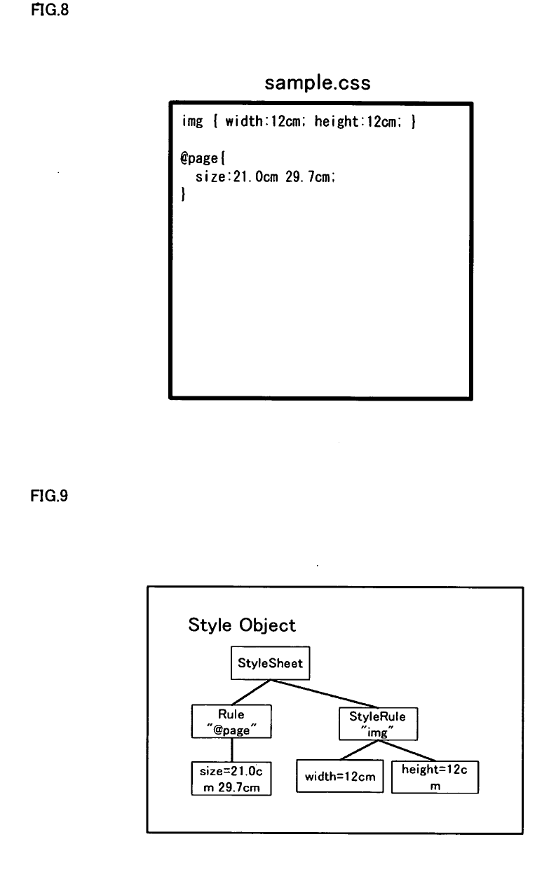

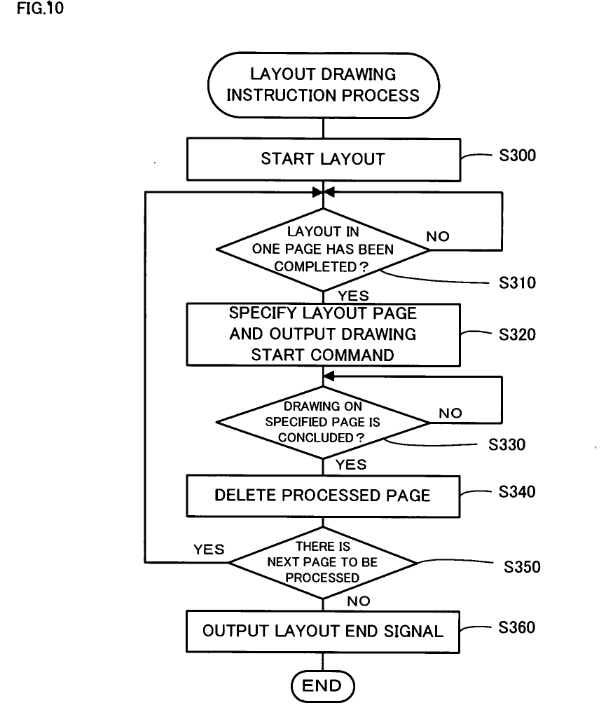

On completion of analysis of all the statements embedded in the XHTML document, the analyzer unit 30 reads a CSS document specified by the XHTML document (step S214) and analyzes the CSS document to create a style object (step S216). According to the concrete procedure, the CSSPI 36 reads the specified CSS document in response to a request given in an initialization process in a link tag of the created DOM tree, sequentially analyzes the CSS document from the top to create rules as a style object, and stores the created style object into the style object storage area of the memory 50. FIG. 8 shows a CSS document specified by the XHTML document of the example. FIG. 9 shows a style object created by analysis of this CSS document.

After creation of the DOM tree and the style object, the analyzer unit 30 correlates the DOM tree with the style object (step S218) and deletes the URL as the object of analysis from the URL storage buffer area (step S220), before terminating the analysis process.

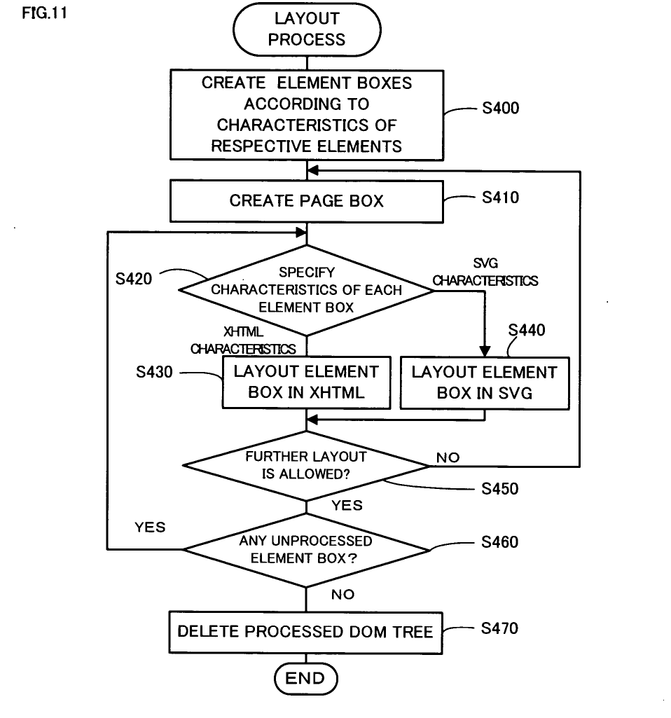

The description regards the series of processing executed by the layouter 38. FIG. 10 is a flowchart showing a layout drawing instruction process executed by the layouter 38 when the analyzer unit 30 specifies a DOM tree and outputs a layout start command. In the layout drawing instruction process, the layouter 38 starts a layout according to the specified DOM tree (step S300). The layout is made according to a layout process shown in the flowchart of FIG. 11. For convenience of explanation, the layout process is described first.

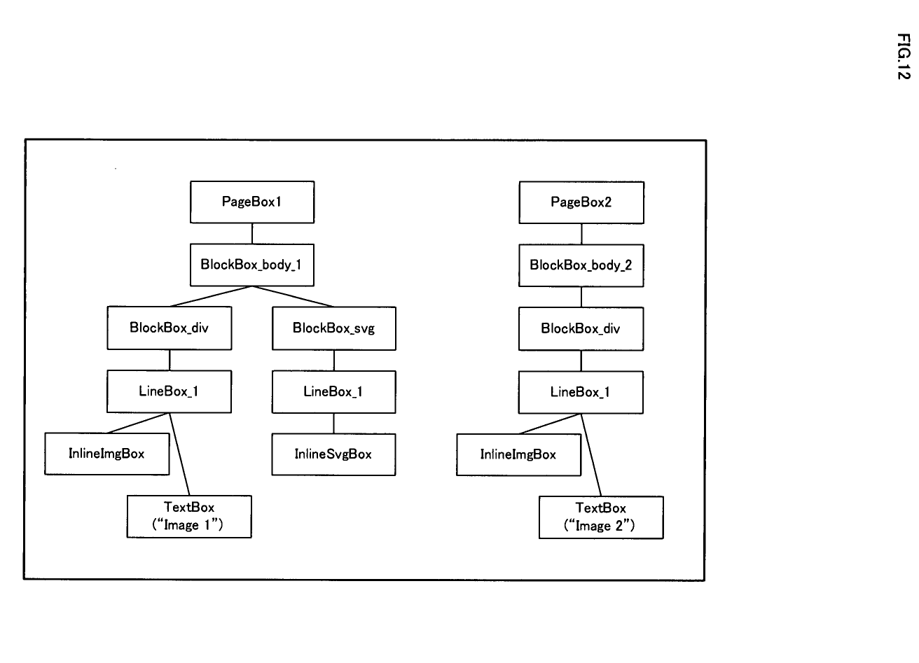

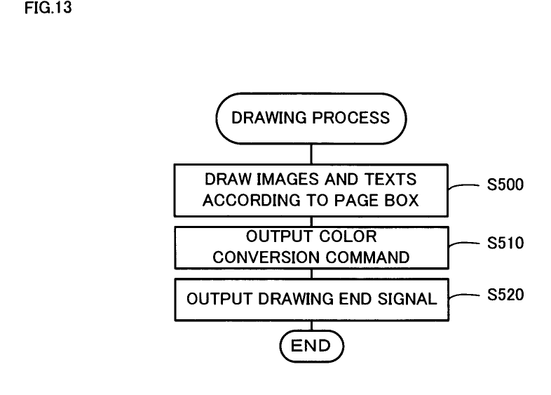

In the layout process, the layouter 38 first creates element boxes according to the characteristics of the respective elements included in the DOM tree (step S400). For example, the layouter 38 creates an image box corresponding to an image element, a text box corresponding to a text element, and a svg box corresponding to an element of a vector figure written in SVG. The layouter 38 subsequently creates a page box corresponding to one page (step S410) and sequentially lays out element boxes in a body tag under the page box until prohibition of further layout (steps S420 to S460). The layout of element boxes specifies the characteristics of each element box (step S420). An element box having the XHTML characteristics, for example, an image box or a text box, is laid out in XHTML. For example, the layout of an image box reads an image size, sets lines corresponding to the image size, and registers the image box on the lines. When the image size suggests an insufficient space for layout of the image box, further layout is prohibited at step S450. The layouter 38 accordingly creates another page box corresponding to a next page (step S410). The layout of text boxes creates a first text box corresponding to a first part of a text receivable in one line, registers the first text box on the line, creates a next text box corresponding to a next part of the text receivable in a next line, and registers the next text box on the next line. Such creation and registration are repeated to register all the text. In the event of failed registration of all the text to a last text box registered on a last line of one page, further layout is prohibited at step S450. The layouter 38 accordingly creates another page box corresponding to a next page and successively creates text boxes corresponding to the remaining text and registers the text boxes on respective lines in the above manner. An element box specified to have the SVG characteristics at step S420, that is, an svg box, is laid out in SVG. In the layout process of the svg box, the layouter 38 instructs the SVGPI 37 to output the dimensions of a box. The SVGPI 37 then outputs the vertical and lateral printing dimensions of a vector figure written in the statement as the dimensions of a box. The layouter 38 sets lines corresponding to the dimensions of the vector figure and registers the svg box on the lines, in a similar manner to the processing of the image box. When the dimensions of the vector figure suggest an insufficient space for layout of the svg box, further layout is prohibited at step S450. The layouter 38 accordingly creates another page box corresponding to a next page (step S410). FIG. 12 shows page boxes of respective pages as a result of layout according to the DOM tree of the example. After completion of the layout of all the element boxes, the layouter 38 deletes the specified DOM tree as the object of layout from the DOM tree storage area of the memory 50 (step S470) and terminates the layout process. The DOM tree as the object of layout is deleted from the DOM tree storage area of the memory 50 on conclusion of the layout process. This arrangement desirably prevents unnecessary storage of the processed DOM tree in the limited space of the DOM tree storage area and sets a space for storage of another DOM tree created by the analyzer unit 30.

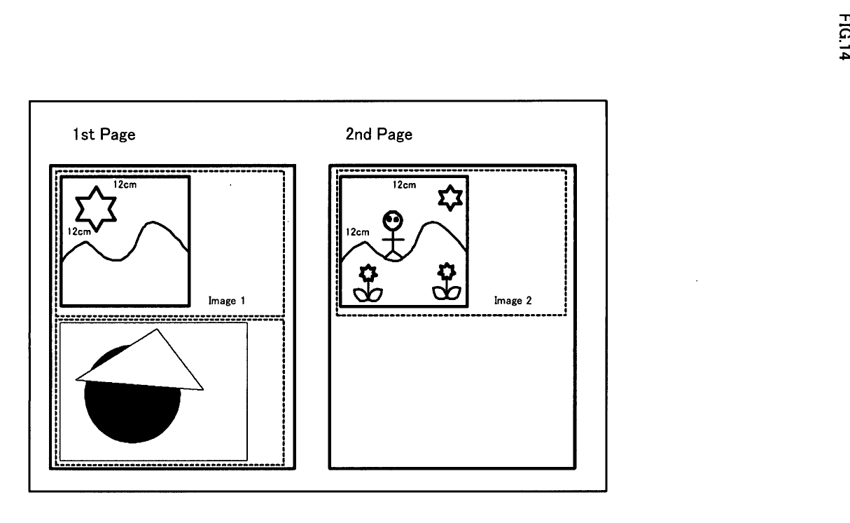

Referring back to the layout drawing instruction process (FIG. 10), the layouter 38 waits for completion of layout in one page (step S310) and specifies the layout page and outputs a drawing start command to the RP 140 (step S320). Completion of layout in one page is detected by determining whether or not a page box corresponding to a next page has been created or whether or not the layout process has been concluded in the case of only one page. The RPI 40 receives the drawing start command and executes a drawing process shown in the flowchart of FIG. 13. The RPI 40 draws texts, images, and vector figures according to the page box and stores the drawn texts, images, and vector figures as RGB data in the printing image storage area of the memory 50 (step S500). In response to a command ‘InlineImgBox’ corresponding to an image box, the drawing process reads an image file and draws an image after extension or any other operation required in some file format. In response to a command ‘InlineSvgBox’ corresponding to an svg box, the drawing process instructs the SVGPI 37 to draw a vector figure in the printing image storage area of the memory 50. On completion of the drawing, the RPI 40 outputs a color conversion command to the color conversion unit 42 (step S510) and outputs a drawing end signal to the layouter 38. FIG. 14 shows a printing result of the example. The broken lines represent virtual areas of div tags and an svg tag included in the body tag, and the dimensions ‘12 cm’ shown on the top and the left sides of each image represent the image size described in the CSS document. The actual printing result naturally does not include such areas of the div tags and the svg tag or the image size.

After output of the drawing start command, the layouter 38 waits for completion of drawing on the specified page (step S330) and deletes the page box corresponding to the processed page (step S340). The page box as the object of drawing is deleted on completion of drawing on the corresponding page. This arrangement desirably prevents unnecessary storage of the processed page box in the limited space of a box storage area. After deletion of the processed page box, the layouter 38 determines whether there is a next page to be processed (step S350). When there is a next page to be processed, the processing flow goes back to step S310 to wait for completion of layout in the next page, specify the next layout page, and output a drawing start command to the RP 140. When drawing has been completed on all the pages and there is no other page to be processed, the layouter 38 outputs a layout end signal to the analyzer unit 30 (step S360) and terminates the layout drawing instruction process. The output of the layout end signal from the layouter 38 to the analyzer unit 30 enables the analyzer unit 30 to determine whether the layouter 38 is currently making a layout.

As described above, the color inkjet printer 20 of the embodiment includes the SVGPI 37, which analyzes, lays out, and draws statements written in SVG. The presence of the SVGPI 37 ensures analysis and printing of even an XHTML document including SVG statements, which are not analyzable by the XML parser 34. The color inkjet printer 20 of the embodiment can thus print objects written in SVG, for example, vector figures, simultaneously with objects written in XHTML, for example, images and texts. Every time a specified URL is given, the color inkjet printer 20 of the embodiment stores the specified URL into the URL storage buffer area of the memory 50, whether or not an XHTML document is being currently analyzed. When any URL is present in the URL storage buffer area of the memory 50, the color inkjet printer 20 successively analyzes XHTML documents, whether or not the layouter 38 is currently making a layout. The color inkjet printer 20 accordingly stores a specified URL and reads and analyzes an XHTML document identified by the specified URL, whether or not the layouter 38 is currently making a layout. This arrangement ensures prompt analysis and printing, compared with the prior art printer system that reads and analyzes a next XHTML document identified by a URL for printing on completion of printing one XHTML document.

The memory 50 included in the color inkjet printer 20 of the embodiment corresponds to the data storage module of the invention. The XML parser 34 and the SVGPI 37 are equivalent to the statement analysis module of the invention including the main analyzer unit and the auxiliary analyzer unit. The core 32 and the CSSPI 36 correspond to the structural analysis module of the invention. The layouter 38 is equivalent to the layout setting module of the invention. The RPI 40, the color conversion unit 42, the binarization unit 44, the image buffer 46, and the print execution unit 48 correspond to the print execution module of the invention.

The color inkjet printer 20 of the embodiment includes the SVGPI 37 that analyzes, lays out, and draws statements written in SVG or the standard vector graphic format. The color inkjet printer 20 may have a module of analyzing, laying out, and drawing statements written in MathML (Mathematical Markup Language) or a standard format of describing mathematical expressions and a module of analyzing, laying out, and drawing statements written in CML (Chemical Markup Language) or a standard format of describing chemical formulae, in addition to or in place of the SVGPI 37.

The color inkjet printer 20 of the embodiment first analyzes each statement embedded in an XHTML document on the assumption of a statement written in XHTML and in the case of failed analysis, subsequently analyzes the statement on the assumption of a statement written in SVG. One modified procedure may first analyze each statement embedded in an XHTML document on the assumption of a statement written in SVG and in the case of failed analysis, subsequently analyze the statement on the assumption of a statement written in XHTML.

In the color inkjet printer 20 of the embodiment, the SVGPI 37 is constructed as an independent functional block. In one modified structure, the functions of the SVGPI 37 may be divided into separate modules. The module of recognizing and registering svg elements is included in the analyzer unit 30. The module of outputting the dimensions of each svg box is included in the layouter 38. The module of drawing vector figures is included in the RPI 37.

When any URL is present in the URL storage buffer area of the memory 50, the color inkjet printer 20 of the embodiment successively analyzes XHTML documents, regardless of the number of DOM trees stored in the DOM tree storage area of the memory 50. When the number of DOM trees stored in the DOM tree storage area of the memory 50 reaches a preset number, analysis of a next XHTML document may be sustained until the number of the stored DOM trees decreases below the preset number. The preset number is, for example, 2. This arrangement desirably reduces the required capacity of the DOM tree storage area in the memory 50.

When any URL is present in the URL storage buffer area of the memory 50, the color inkjet printer 20 of the embodiment starts analysis of a next XHTML document immediately after completion of analysis of one XHTML document. Analysis of a next XHTML document may start at any desirable timing after completion of analysis of one XHTML document.

The color inkjet printer 20 of the embodiment analyzes and prints an XHTML document including SVG statements. The technique of the invention is generally applied to analyze and print a document that is described in one markup language and includes statements written in another markup language. The technique of the invention is also applicable to analyze and print documents described in any language other than the markup languages.

In the configuration of the embodiment, the computer 10, the digital TV receiver 12, and the digital camera 14 are connected to the input interface 22 of the color inkjet printer 20. Any other suitable devices may be connected with the color inkjet printer 20.

The above embodiment regards the color inkjet printer that analyzes and prints XHTML documents as the printing device of the invention. The technique of the invention is also applicable to diversity of other printers, for example, color laser printers, monochromatic inkjet printers, and monochromatic laser printers.

The embodiment and its modified examples discussed above are to be considered in all aspects as illustrative and not restrictive. There may be many other modifications, changes, and alterations without departing from the scope or spirit of the main characteristics of the present invention.

The specification hereof refers to Japanese Patent Application No. 2003-369031 (filed on Oct. 29, 2003) and incorporates herein all the details of the specification, the drawings, and the claims disclosed therein.

1. A printing device that analyzes a document of describing printable objects in a hierarchical manner and prints the objects on a medium, such as paper, said printing device comprising:
a data storage module that stores data;
a statement analysis module having a main analyzer unit and at least one auxiliary analyzer unit, where said main analyzer unit analyzes a statement of describing a printable object with an identifier in a preset format and said auxiliary analyzer unit analyzes a statement of describing a printable object with an identifier in another format different from the preset format;
a structural analysis module that, in response to specification of one document, analyzes a hierarchical tree structure of the objects included in the specified document, in cooperation with said main analyzer unit and said auxiliary analyzer unit included in said statement analysis module, and stores the analyzed tree structure into said data storage module;
a layout setting module that, in response to a layout command, determines a layout of the objects in each page on the medium based on the tree structure stored in said data storage module, in cooperation with said main analyzer unit and said auxiliary analyzer unit included in said statement analysis module, and stores the determined layout in each page into said data storage module; and
a print execution module that, in response to a print command, fetches the objects according to the determined layout in each page stored in said data storage module and lays out and prints the fetched objects on the medium.

2. A printing device in accordance with claim 1, wherein said structural analysis module activates said auxiliary analyzer unit of said statement analysis module, in the case of failed analysis of a statement by said main analyzer unit of said statement analysis module.

3. A printing device in accordance with claim 1, wherein the statement specifies a type of each object, and
said structural analysis module analyzes the tree structure, based on an identifier and the specified type of each object.

4. A printing device in accordance with claim 1, wherein said auxiliary analyzer unit gives a printing size of the object described in the analyzed statement as part of the analysis, and
said layout setting module refers to the printing size of the object given as part of the analysis by said auxiliary analyzer unit and determines the layout of the objects.

5. A printing device in accordance with claim 1, wherein said structural analysis module gives the layout command with specification of the analyzed tree structure to said layout setting module, after the analysis of the tree structure.

6. A printing device in accordance with claim 1, wherein said layout setting module gives the print command for each page with the determined layout to said print execution module.

7. A printing device in accordance with claim 1, wherein said layout setting module gives the print command on completion of determination of the layout for one page to said print execution module.

8. A printing device in accordance with claim 1, wherein the document is described in a markup language.

9. A printing device in accordance with claim 1, wherein the preset format describes an object corresponding to at least one of a text, an image, and a table, and
the another format describes an object corresponding to at least one of a figure, a combination of figures, and a mathematical expression.

10. A printing device in accordance with claim 9, wherein the statement of describing the printable object with the identifier in the preset format is a statement written in XHTML language, and
the statement of describing the printable object with the identifier in the another format is a statement written in one of SVG language, MathML language, and CML language.

11. A printing device in accordance with claim 1, said printing device being a color inkjet printer.

12. A printing method that analyzes a document of describing printable objects in a hierarchical manner and prints the objects on a medium, such as paper, said printing method comprising the steps of:
(a) in response to specification of one document, analyzing each statement included in the specified document on the assumption of a statement with an identifier in a preset format, and in the case of failed analysis of the statement on the assumption of the statement with the identifier in the preset format, subsequently analyzing the statement on the assumption of a statement with an identifier in another format different from the preset format, so as to complete analysis of a hierarchical tree structure of the objects included in the specified document;
(b) in response to a layout command, laying out each object of the tree structure analyzed on the assumption of the statement with the identifier in the preset format, based on the statement with the identifier in the preset format, while laying out each object of the tree structure analyzed on the assumption of the statement with the identifier in the another format, based on a printing size of the object given as part of the analysis of the statement, so as to determine a layout of the objects in each page on the medium; and
(c) in response to a print command, fetching the objects according to the determined layout in each page and laying out and printing the fetched objects on the medium.

13. A storage medium in which a program is stored, said program being used in a printing device that analyzes a document of describing printable objects in a hierarchical manner and prints the objects on a medium, such as paper,
said program comprising: a statement analysis module having a main analyzer module and at least one auxiliary analyzer module, where said main analyzer module analyzes a statement of describing a printable object with an identifier in a preset format and said auxiliary analyzer module analyzes a statement of describing a printable object with an identifier in another format different from the preset format; a structural analysis module that, in response to specification of one document, analyzes a hierarchical tree structure of the objects included in the specified document, in cooperation with said main analyzer module and said auxiliary analyzer module included in said statement analysis module; a layout setting module that, in response to a layout command, determines a layout of the objects in each page on the medium based on the analyzed tree structure, in cooperation with said main analyzer module and said auxiliary analyzer module included in said statement analysis module; and an execution module that, in response to a print command, fetches the objects according to the determined layout in each page and lays out and prints the fetched objects on the medium.
